(19) United States
(12) Patent Application Publication
(10) Pub. No.: US 2012/0001428 A1
(43) Pub. Date: Jan. 5, 2012

(54) WIND ENERGY SYSTEM

(76) Inventors: Scott W. Calhoon, Oklahoma City, OK (US); Sam M. John, Yukon, OK (US)

(21) Appl. No.: 13/175,842

(22) Filed: Jul. 2, 2011

Related U.S. Application Data
(60) Provisional application No. 61/361,006, filed on Jul. 2, 2010.

(51) Int. Cl. H02P 9/04

(52) U.S. Cl. 290/44

(57) ABSTRACT

A wind energy system continuously responsive to changes in wind direction and speed. The system includes a low-profile, rotatably-mounted turbine assembly. The turbine assembly includes a wind tunnel with a “cow catcher” style wind gatherer. The tunnel defines a narrowed throat portion between the inlet and outlet to increase the wind speed. A turbine mounted on a stand is fitted inside the outlet end of the tunnel, and may be movable fore and aft in response to changes in wind speed. A control system receives regular wind change forecasts from a third party, and automatically repositions the rotating turbine assembly in response to real-time predicted changes in wind vector and may also move the turbine axially relative to the throat in the tunnel in response to real-time predicted changes in wind speed. Additionally, the turbine may be turned out of the wind to avoid excessively high winds.

### CROSS-REFERENCE TO RELATED APPLICATION(S)

This application claims the benefit of the filing date of U.S. provisional application No. 61/361,006 filed Jul. 2, 2010, entitled “Wind Energy System,” and the contents of that provisional application are incorporated herein by reference.

### FIELD OF THE INVENTION

The present invention relates generally to wind energy systems, and, more particularly but without limitation, to systems that convert wind to electricity.

### BRIEF DESCRIPTION OF THE DRAWINGS

FIG. 1 is a frontal perspective view of a wind energy system constructed in accordance with a preferred embodiment of the present invention.

FIG. 2 is a rear perspective view of the wind energy system shown in FIG. 1.

FIG. 3 is a rear perspective, exploded view of the wind energy system shown in FIG. 1.

FIGS. 4A and 4B show a wind energy system with a linear rail assembly for slidably supporting the turbine tower on the base of the turbine system. In FIG. 4A, the turbine is in its forwardmost position, and in FIG. 4B the turbine is moved aft to its rearwardmost position.

FIG. 5 is a side elevational view of the trolley and motor assembly on which rotates the turbine assembly.

FIG. 6 is an end view of the trolley and motor assembly.

FIG. 7A is frontal perspective view of the turbine.

FIG. 7B is a rear perspective view of the turbine.

FIG. 7C is an exploded side perspective view of the turbine.

FIG. 8 is a frontal perspective view of the blade assembly of the turbine of the wind energy system shown in FIG. 1.

FIG. 9 is a side perspective, exploded view of the blade assembly of the turbine of the wind energy system shown in FIG. 1.

FIG. 10 is a rear perspective view of the hub of the blade assembly shown in FIGS. 7-9.

FIG. 11 is a rear elevational view of the hub shown in FIG. 10.

FIG. 12 is a front elevational view of the hub shown in FIG. 10.

FIG. 13 is an enlarged fragmented view of the rear of the hub shown in FIG. 10.

FIG. 14A is a proximal end elevation view of the blade and attachment rod.

FIG. 14B is front elevational view of the blade and attachment rod.

FIG. 14C is a distal end elevational view of the blade and attachment rod.

FIG. 14D is a rear elevational view of the blade and attachment rod.

FIG. 14E is an enlarged fragmented view of the attachment end of the blade and rod.

FIG. 14F is a front elevational view of the blade and attachment rod rotated slightly as positioned on the hub.

FIG. 14G is a rear perspective view of the blade and attachment rod.

FIG. 15A is a perspective view of the attachment rod of the blade assembly shown in FIGS. 7-9.

FIG. 15B is a side elevational view of the attachment rod shown in FIG. 14.

FIG. 16 is an end view of a first half of the attachment block of the blade assembly shown in FIGS. 7-9.

FIG. 17 is a side view of the first half of the attachment shown in FIG. 16.

FIG. 18 is a back view of the first half of the attachment block shown in FIG. 16.

FIG. 19 is a rear perspective view of the first half of the attachment block shown in FIG. 16.

FIG. 20 is an end view of a second, mating half of the attachment block of the blade assembly shown in FIGS. 7-9.

FIG. 21 is a side view of second, mating half of the attachment block shown in FIG. 20

FIG. 22 is a back view of the second, mating half of the attachment block shown in FIG. 20.

FIG. 23 is a rear perspective view of the second, mating half of the attachment block shown in FIG. 20.

FIG. 24 is a front elevational view of the hub adapter of the blade assembly shown in FIGS. 7-9.

FIG. 25 is a side elevational view of the hub adapter of the blade assembly shown in FIG. 24.

FIG. 26 is a rear perspective view of the hub adapter of the blade assembly shown in FIG. 24.

FIG. 27 is a side diagrammatic view of the wind tunnel of the wind energy system.

FIG. 28 is a front diagrammatic view of the wind tunnel of the wind energy system showing the relative diameters of the inlet end, outlet end, throat, and nose cone.

FIG. 29 is a perspective view of the wind tunnel of the wind energy system.

FIG. 30 is a logic diagram of the preferred computerized control system for controlling the rotational position of the wind tunnel of the wind energy system of the present invention.

FIG. 31 is a logic diagram of the preferred computerized control system for controlling the axial position of the turbine in the wind tunnel of the wind energy system of the present invention.

FIG. 32 is a schematic illustration of the control system and its interactive relationship with the turbine assembly and the third party wind data supplier.

### DETAILED DESCRIPTION OF THE PREFERRED EMBODIMENT(S)

As energy from fossil fuels becomes more costly and the supplies dwindle, efficient and broad-based use of wind energy becomes an important alternative or supplemental source. Large “wind farms” effectively capture and convert wind into electricity. However, wind farms occupy large areas, are unsightly, and cause the deaths of many birds.

The present invention comprises a system and method that utilize a wireless and continuous feed of wind change data from a third party provider to anticipate and respond preemptively to wind direction and speed, thus allowing for most efficient kinetic energy harvest. The present invention provides a highly efficient turbine system with a smaller footprint and less obtrusive profile on the landscape. The inventive system employs a wind tunnel that concentrates and enhances the wind energy directed to the turbine.

This low profile system is able to produce power comparable to class 4 wind sites when located in a class 2 wind site. It is less expensive to build and to operate, substantially reducing the cost of energy per kilowatt hour. The system is quiet and produces no “flickering” effect and thus reduces complaints of nearby residents. Since the system may be ground based and the turbine is housed inside a wind tunnel protected by a debris guard, injury to birds is eliminated. Because the system is either ground based or low profile relative to its supporting surface, the system is easier and safer to maintain and service.

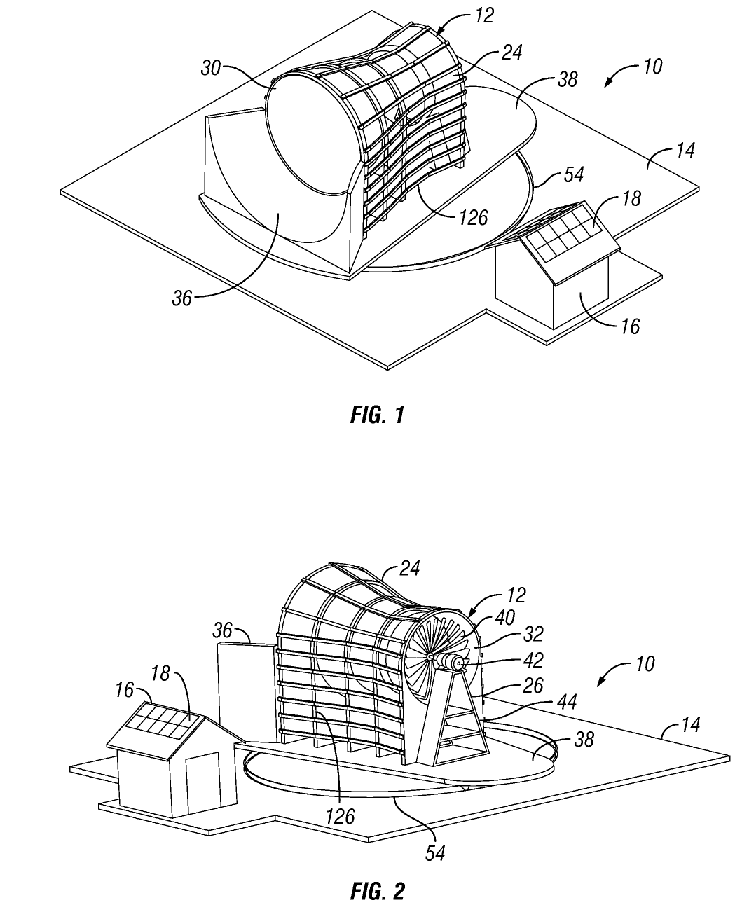

Turning now to the drawings in general and to FIGS. 1-3 in particular, there is shown therein and designated generally by the reference number 10 a wind energy system constructed in accordance with a preferred embodiment of the present invention. The system 10 preferably comprises a turbine assembly 12 mounted on a supporting platform 14 with a control house 16.

In the exemplary system 10, the platform 14 is a solid, concrete pad. However, the nature of the platform may vary depending on its location. While a concrete pad is suitable for a permanent, ground-based system 10 as shown, other types of supporting platforms may be used when the system is placed in other types of locations. For example, the system of the present invention may be located on a roof or other elevated structure where an open framework of some sort may be preferred. Further, in some locations, the system may be placed on a larger concrete surface, such as a runway or parking lot, in which no additional platform is required. Still further, in some applications, the system 10 may be mobile or portable as, for example, on a trailer or other transport.

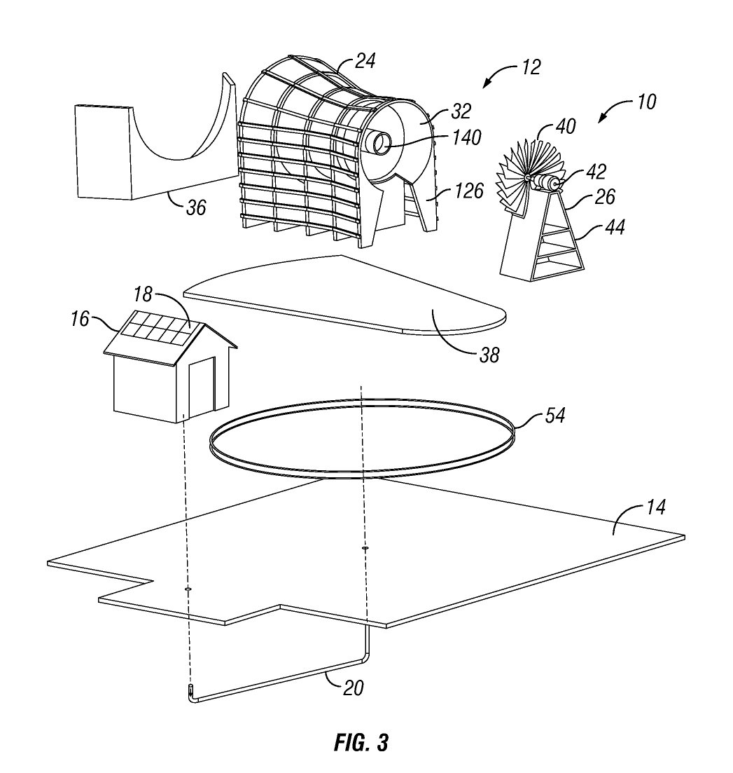

The control house 16 is a small structure designed to house a computer control system, to be described more fully below, as well as a controller/inverter and battery storage. The computer system in the control house 16 is connected by electrical, fluid (hydraulics), and data conduits 20 (FIG. 3) to the turbine assembly 12. These connections may be buried under the platform 14. The roof of the house 16 may comprise solar panels 18 for powering the control system and other power-driven components of the system, such as the motors for driving the rotational movement of the turbine assembly and the axial movement of the turbine.

The turbine assembly 12 may comprises a wind tunnel 24 and a turbine 26 positioned to receive wind passing through the tunnel 24. The wind tunnel 24 has an inlet 30 and an outlet 32. A wind gatherer 36 preferably is provided at the inlet 30. Most preferably, the wind gatherer 36 is a “cow catcher” style structure that extends around the lower half of the inlet 30. However, the size, extent, and shape of the wind gatherer may vary.

Notably, the preferred “cow catcher” extends around the entire bottom half of the inlet and is about four (4) feet wide. Thus, the gatherer adds 180 degrees of extra gathered wind and substantially expands the gathered area. Thus, the actual swept area in the present wind energy system is not simply the span of the turbine blades. Rather, the true swept area is the area of the inlet plus the extended area of the wind gatherer, which in the embodiment described herein increases the swept area to about two hundred percent (200%) of the area spanned by the turbine's blade assembly.

The inlet 30 may be provided with additional wind gathering devices, such as sails or spinnakers. U.S. Pat. No. 7,368,828, issued May 6, 2008 to Scott C. Calhoon for “Wind Energy System,” and of U.S. Pat. No. 7,893,553, issued Feb. 22, 2011, to Scott C. Calhoon for “Wind Energy System,” show and describe such structures for gathering wind into a horizontal air conduit, and the contents of these two patents are incorporated herein by reference.

In most instances, the wind tunnel 24, turbine 26, and gatherer 36 will be supported together on a base 38. The size, shape, and structure of the base 38 may vary. In some cases, the base may be a solid sheet of wood, metal, or fiberglass. In other cases, it may be advantageous to make the base an open structure of metal or wood beams.

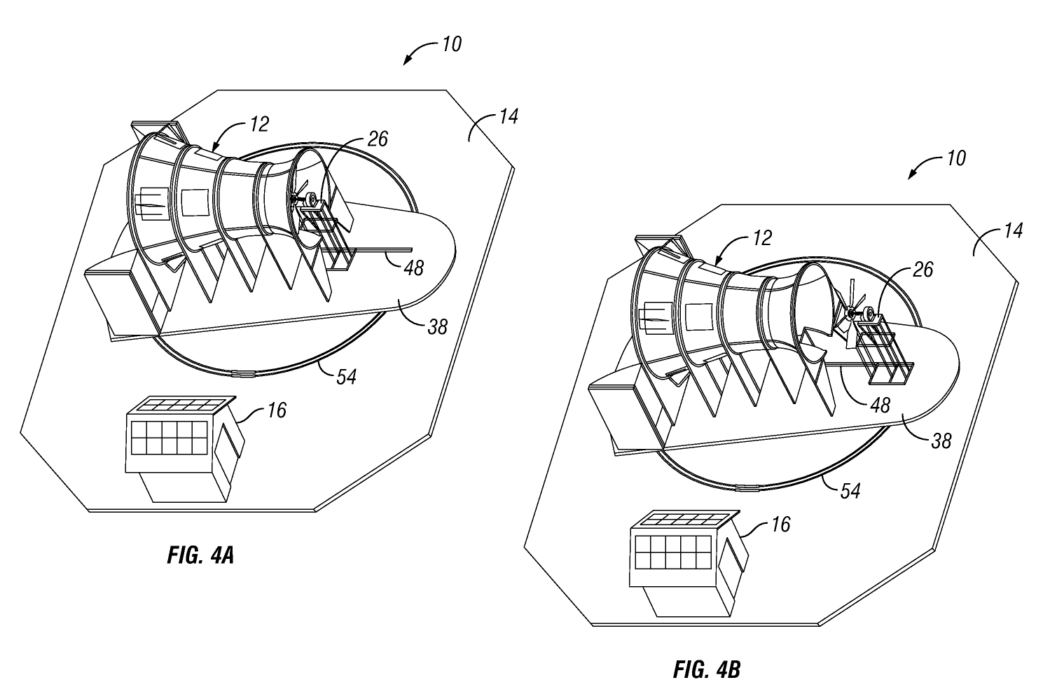

The turbine 26 comprises a blade assembly 40 and a generator 42 mounted on a stand 44. As best seen in FIG. 2, the turbine 26 is configured so that the blade assembly 40 fits inside the outlet 32 of the wind tunnel 24. In the exemplary system, the blade span is about 8 feet. In the preferred embodiment of the system 10, the stand 44 is mounted for linear axial movement fore and aft relative to the wind tunnel 24. This allows the turbine 26 to be positioned optimally relative to wind speed through the tunnel, which will vary with the ambient wind speed. For example, as shown in FIGS. 4A and 4B, the stand 44 may be mounted on rails 48. Movement of the stand 44 may be manual or motor-driven. Additionally, motorized movement may be automatically controlled by the computer system yet to be described.

The turbine assembly 12 preferably is rotatably mounted so that it can be realigned frequently in response to real-time predicted wind direction changes in a manner described in more detail hereafter. To that end, a rotation assembly 50 may be provided between the base 38 and platform 14. In this preferred embodiment, the rotation assembly comprises a circular monorail and a motorized trolley system that will permit full (360°) rotation. However, it will be appreciated that the rotation assembly 50 may take other forms.

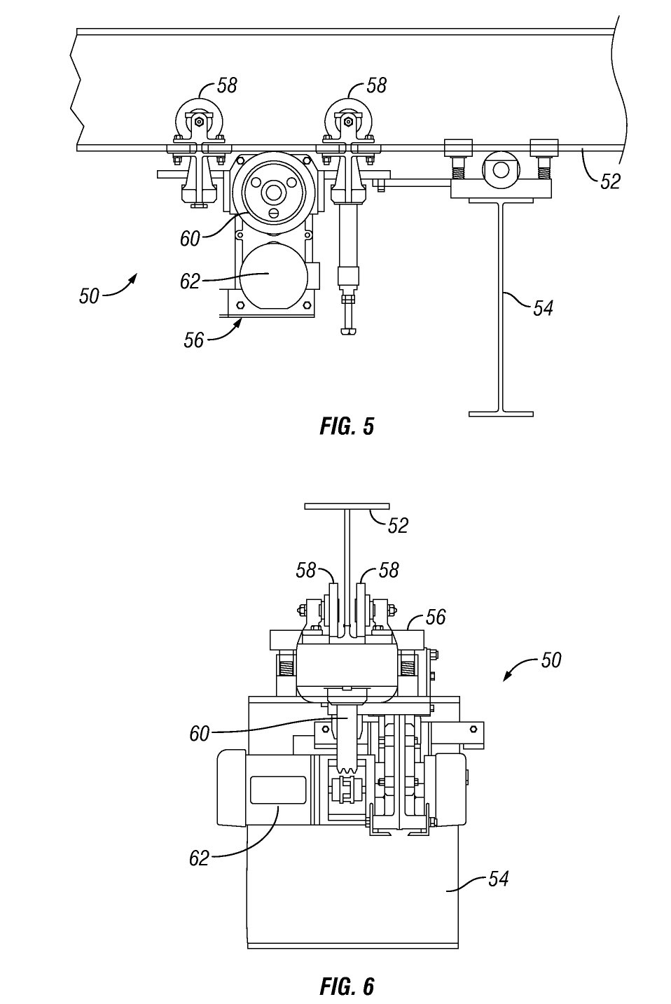

With reference now also to FIGS. 5 and 6, the circular rail 52 is secured to the base 38 by bolts (not shown) or in some other suitable manner. In most cases, the rail 52 will be movingly supported a distance above the platform 14 by vertical supports 54 (FIGS. 5 & 6). At least one motorized trolley 56 is fixed relative to one of the vertical supports 54. The trolley 56 may comprise upper and lower wheels 58 and 60, with the lower drive wheel 60 being driven by the motor 62. As shown, the rail 52 may be an I-beam, in which case the trolleys 56 may have inner and outer upper wheels 58. Additional non-motorized trolleys (not shown) may be included for a well-balanced system. The motor 62 preferably is automatically controlled by the computer system described hereafter. Most preferably, the power for this rotation is provided by the solar panels 18 on the roof of the control house 16.

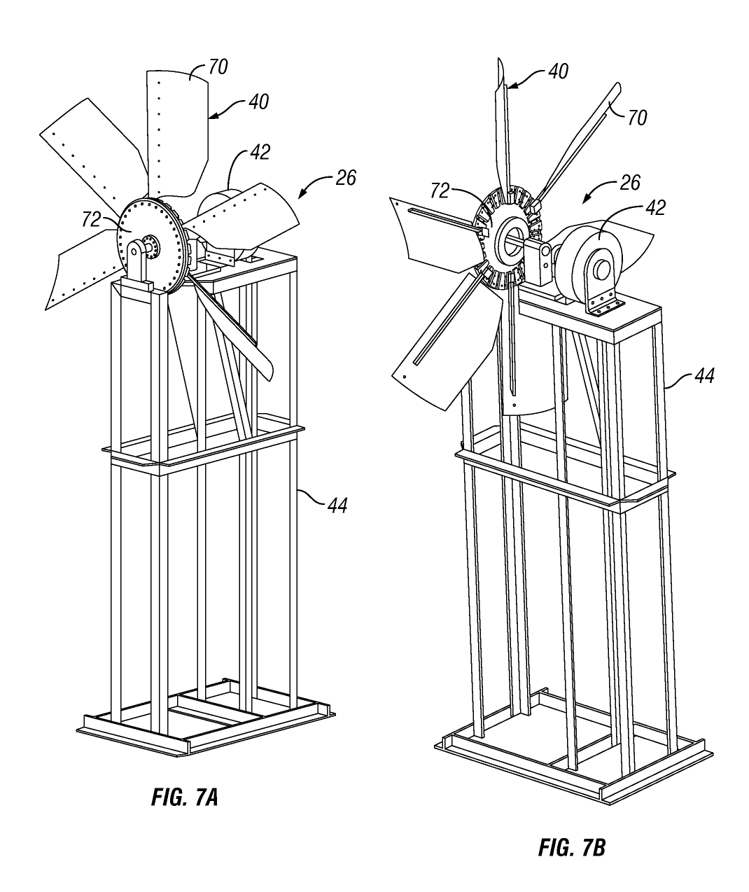

As indicated previously, the turbine 26 comprises a blade assembly 40 that is connected to a generator 42 supported on a stand 44, as best seen in FIGS. 7A, 7B, and 7C. The turbine 26 may be of any type or brand suitable for a wind turbine, but a horizontal-axis wind turbine (“HAWT”) type of turbine is preferred in most applications. One suitable wind turbine is the Bergey XL.1 wind turbine available from Bergey Windpower Co., 2200 Industrial Blvd., Norman Okla. 73069 USA. The Bergey XL.1 is rated to 1000 Watts power (peak output of 1300 watts) and 11 m/s (24.6 mph) wind speed. However, in the preferred embodiment, the blade assembly 40 will accommodate a larger capacity generator, such as a 3-10 kW generator. A direct drive generator is ideal.

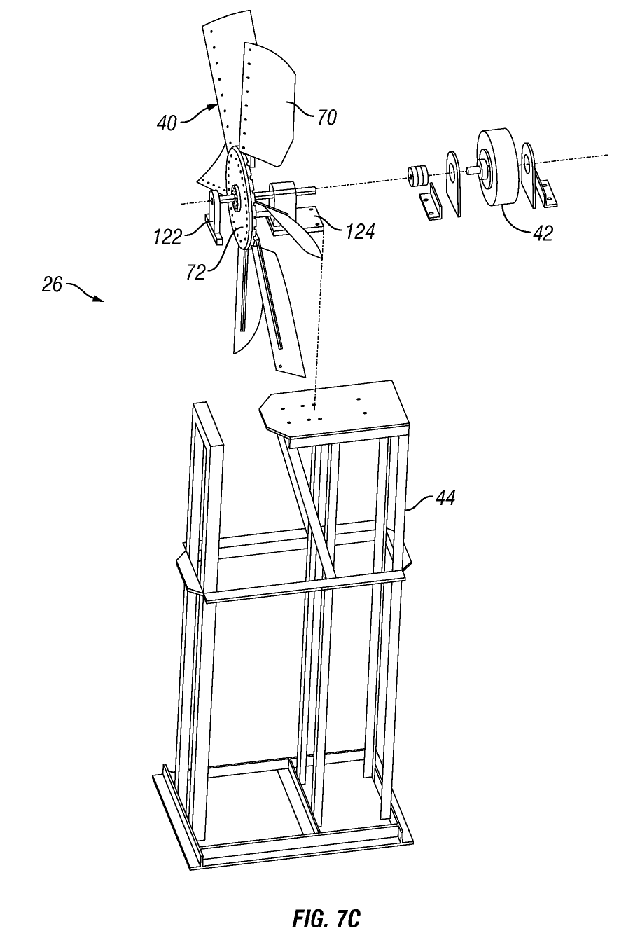

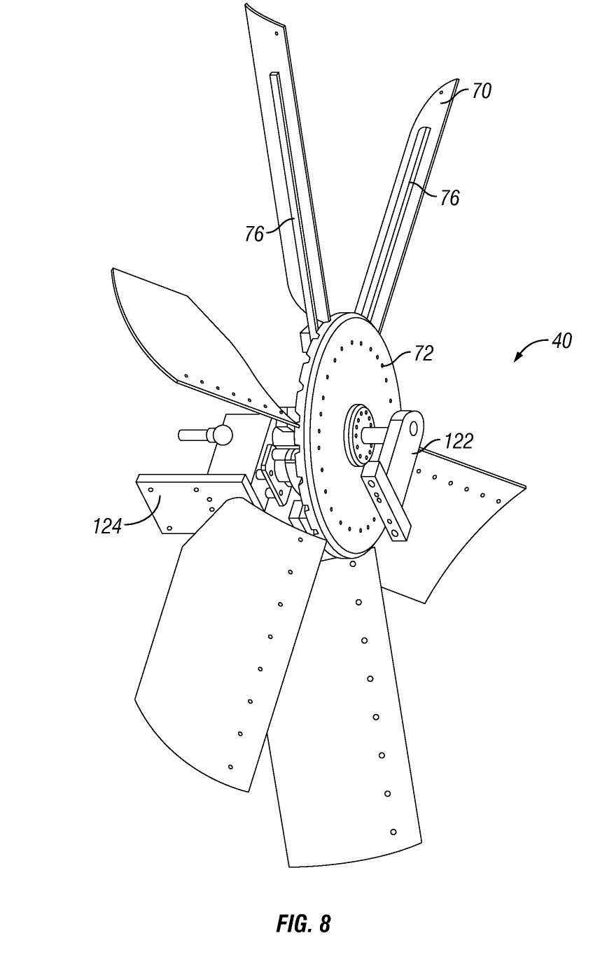

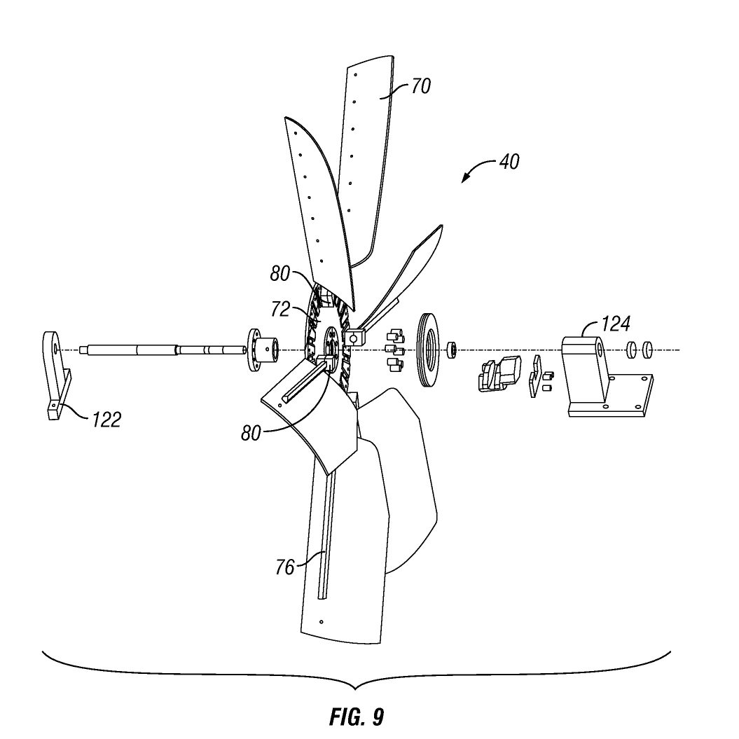

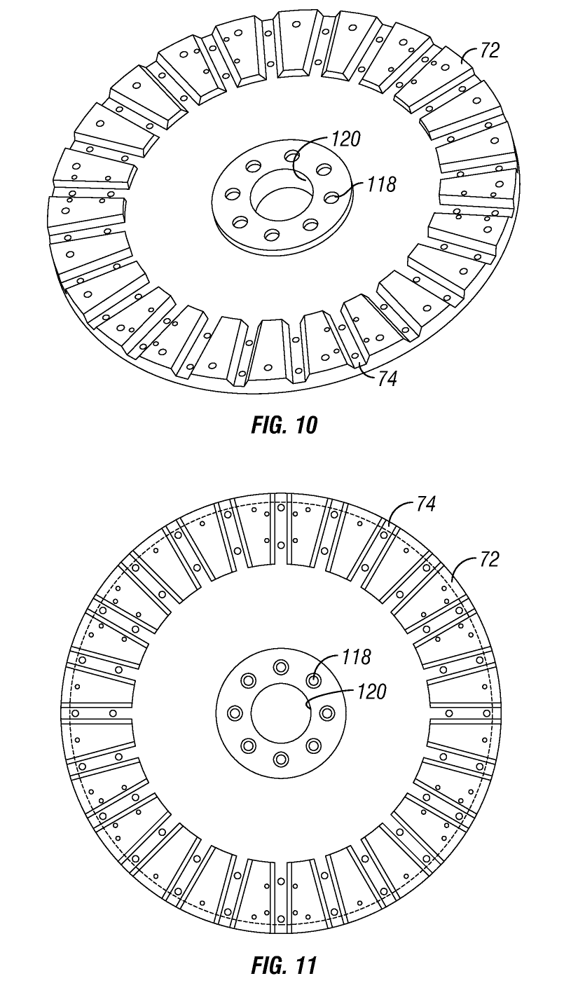

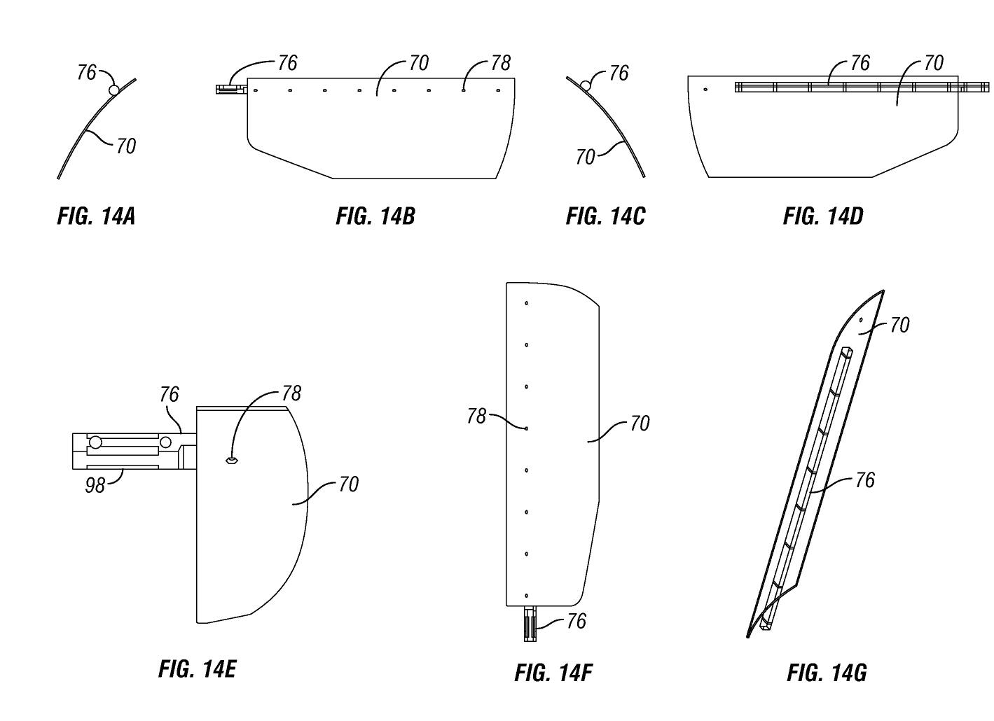

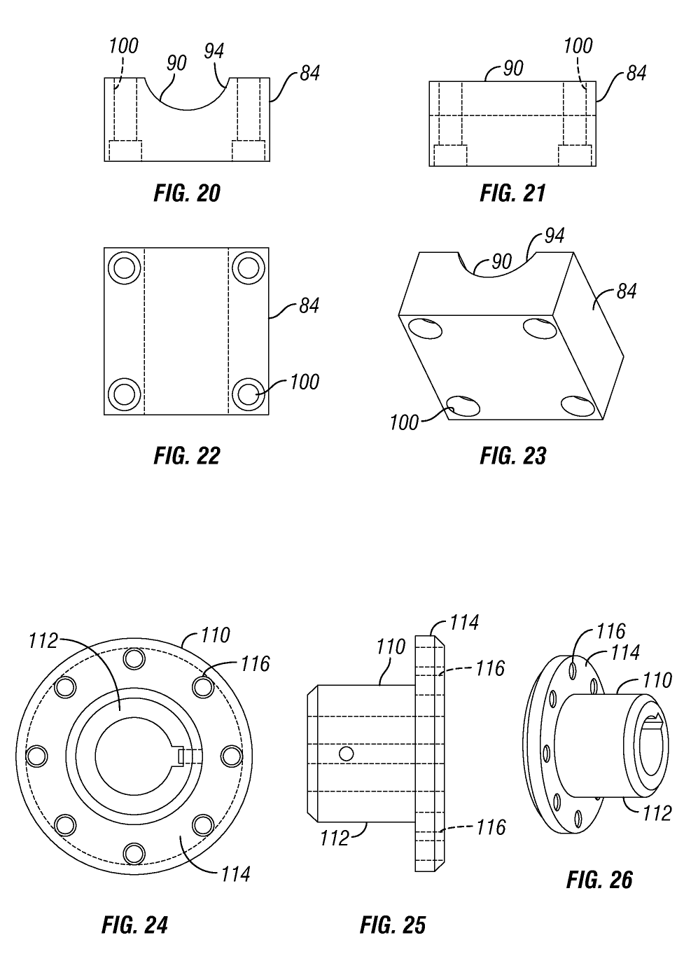

The preferred blade assembly now will be described with reference to FIGS. 8-26. As best seen in FIGS. 8 and 8, the preferred blade assembly 40 comprises one or more blades 70 supported on a hub 72 for rotation relative to the generator housing 42. The configuration of the blades 70 may vary, but a generally rectangular and slightly curved, aerodynamic shape is preferred. A particularly preferred blade configuration is illustrated in FIGS. 14A-14G. In the preferred embodiment shown, six (6) metal blades are utilized, but the blade assembly 40 may have more or fewer blades. While the preferred construction is metal, the blades alternately may be made of composite or another suitable material.

The blades 70 are mounted around the periphery of a center plate or hub 72, as shown best in FIGS. 8-9. The blades 70 may be permanently or removably mounted, but preferably are removably mounted for maintenance, repair, and replacement as needed. In some instances, the blades 70 may be non-adjustably attached to the plate, and in other cases, the blades may be adjustably mounted. The hub 72 shown includes mounting holes for both adjustable and non-adjustable blade attachments.

It should be noted that the blades 70 are mounted to back or rear face of the hub 72. This makes the blade attachment points readily accessible from the rear; there is no need to move the stand 44 or to enter the tunnel 24 in order to service, repair or replace blades.

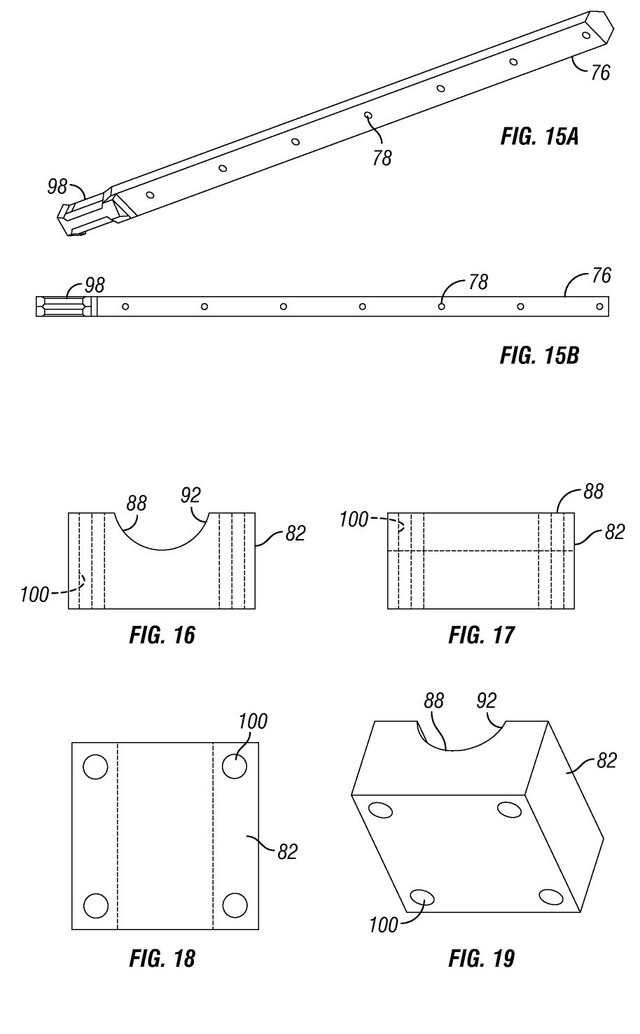

The hub 72 preferably includes radial grooves or slots 74 sized to receive attachment rods 76 seen in FIGS. 15A and 15B. The rods 76 include bolt holes 78 (FIGS. 14 & 15) by which the rods are attached along the edges of the blades 70. This attachment is only one of several possible means for attaching the rods to the blades.

Similarly, there are various ways to secure the end of the rods 76 to the hub 72. However, the preferred attachment employs an attachment block 80 (FIG. 9) comprising two halves 82 and 84 shown best in FIGS. 16-23. The inner faces 88 and 90 of the attachment block 80 define two halves of a circular recess at 92 and 94 configured to receive the end 98 of the rod 76. Corner bolt holes in the blocks 80, all designated generally at 100, are aligned with bolt holes 102 (FIG. 13) in the hub 72.

Referring still to FIGS. 15A and 15B, the rod is generally hexagonal in cross section. However, a short segment near the end 98 of the rod 76 (see also FIG. 14E) is rounded to permit rotation of the rod to any degree inside the attachment blocks 80. The very end of the rods 76 have the hexagonal shape; this allows the use of a degree measuring device on the end to ensure that all the blades 70 are oriented to precisely the same position.

Thus, bolts (not shown) secure the halves 82 and 84 of the blocks together and attach the rod 76 to the hub 72. It will be apparent now that the circular recesses 92 and 94 allow the ends 98 of the rods 76 to be rotated, when the attachment bolts (not shown) are loosened, to thereby rotate the blades 70 relative to the center plate, as desired. Alternately, bolts (not shown) may attach the ends 98 of the rods 76 directly to the hub 72 using the bolt holes 106, also shown in FIG. 13.

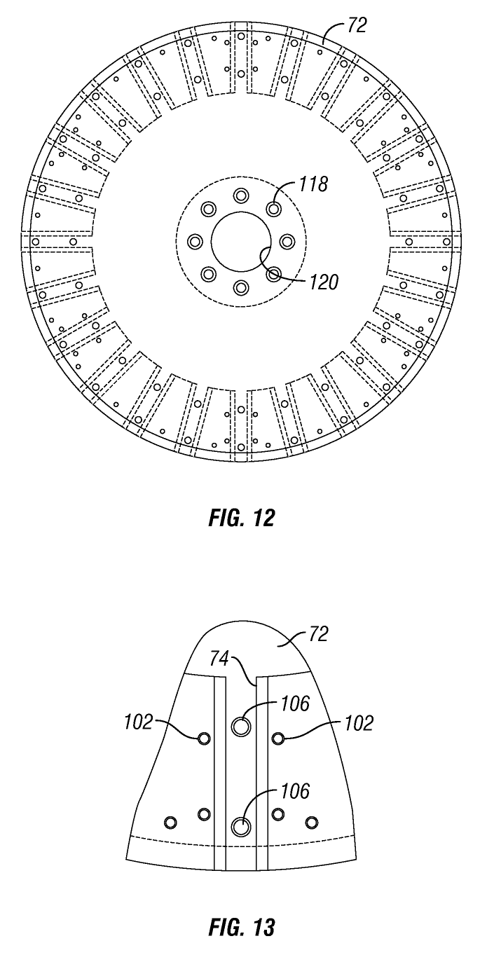

The hub 72 is mounted on the shaft (not shown) of the generator by an adapter 110 (FIGS. 24-26). The adapter 110 comprises a tubular body 112 with an annular flange 114 having bolt holes 116 that mate with bolt holes 118 (FIG. 12) around the center bore 120 in the hub 72. Of course, this particular mounting arrangement is not limiting.

Additionally, in the preferred turbine structure, the blade assembly 40 is braced to the stand 44 both in the front and the rear of the hub 72. To that end, the blade assembly 40 comprises a front brace 122 and a rear brace 124, as best seen in FIGS. 7C, 8 and 9. This stabilizes the blade assembly 40 and allows it to function more efficiently.

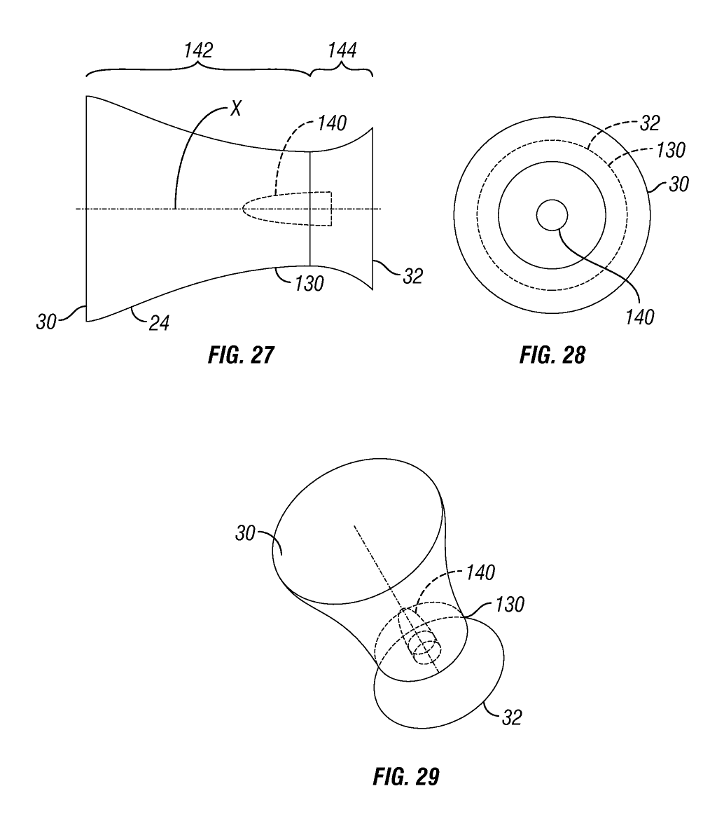

Turning now to FIGS. 27 to 29, the preferred configuration for the wind tunnel 24 will be described. As used herein, “tunnel” denotes a tubular structure of uniform or non-uniform diameter. More preferably, the wind tunnel 24 has a non-uniform diameter. The wind tunnel 24 may be constructed of any suitable material, but fiberglass is believed to be ideal and is less expensive than most metals.

The tunnel 24 may be supported over the base 38 by any suitable frame work or structure, designated herein generally at 126 (FIGS. 1&2). Although not depicted herein, the inlet 30 of the tunnel 24 may be covered with a wire mesh or screen to prevent birds and flying debris from entering the tunnel.

More specifically, the wind tunnel 24 preferably has narrowed throat section 130 between the inlet 30 and the outlet 32. Centered in this narrow throat 130 is a nose cone 140. The nose cone 140 is supported by spokes or another suitable structure (not shown) immediately in front of the center of the blade assembly 40 of the turbine 26. In this way, the nose cone 140 diverts the wind at the center of the tunnel 24 towards the blades 70 rather than towards the dead space at the hub of the blade assembly 40.

Although the dimensions of the tunnel 24 may vary, in one preferred embodiment the dimensions are as follows: overall length of the tunnel 24—about 16.7 feet; length of the forward segment (from the inlet 30 to the throat 130 designated at 142 in FIG. 27)—about 13.3 feet; length of the rear segment (from the throat 130 to the outlet 32 designated at 143 in FIG. 27)—about 3.3 feet; length of the nose cone—about 5.4 inches; diameter of the inlet—about 13 feet; diameter of the outlet—about 9.3 feet; diameter of the throat—about 7.8 feet; and, diameter of the nose cone—about 2 feet.

In the exemplary system shown herein, the ratio of the cross-sectional area of the inlet 30 relative to the narrowest point in the throat 130 is about 3.5 to 1, and the ratio of the cross-sectional area of the narrowest point in the throat to the cross-sectional area of the outlet 32 is about 1 to 2.2. In the forward segment of the tunnel 24, then, the cross-sectional diameter gradually narrows toward the throat 130, which causes increased pressure and decreased velocity in the channeled wind. In the rearward segment of the tunnel 24, the cross-sectional diameter gradually expands toward the outlet 32, which causes decreased pressure and increased velocity in the channeled wind as it approaches the turbine 26. The length of the forward segment of the tunnel preferably is at least about twice as long as the rearward segment, and more preferably is about three times as long, and most preferably is four times as long as the rear segment. The length of the forward segment of the tunnel 24 is selected to provide optimal molding of the wind stream and to reduce turbulence.

This particular configuration—the wider inlet 30 feeding to a narrower throat 130 and exiting a slightly large outlet 32—concentrates and streamlines or molds the wind stream as it passes through the tunnel 24, resulting in a substantial increase in air speed in the rearward segment 142 of the tunnel. In other words, the narrowed throat 130 produces a nozzle-like effect on the wind stream. The fore/aft movement of the turbine 26 can be controlled to take maximum advantage of this increased wind speed. Most preferably, this feature is automatically controlled by computer, as described below. To that end, one or more anemometers (not shown) can be installed at locations along the length of the tunnel 24.

The enhanced air speed generates more energy in this inventive ground-based turbine than would be produced by the same turbine exposed to the same ambient winds on an elevated tower. For example, it is expected that the a wind energy system constructed in accordance with the present invention and installed at ground level at a class 2 wind site will produce power equal to that produced by a comparable tower-based wind turbine at a class 4 wind site.

As indicated previously, the turbine 26 may be mounted for linear fore-aft movement. This adjustable positioning of the turbine 26 within the wind tunnel utilizes the physics of the Bernoulli principle and allows for “back to front” positioning of the turbine in the “sweet spot,” that is, the point of the highest maximum velocity, which varies with ambient wind speed.

Power generated by a wind energy system is generally calculated using the following equation:

P=ρ×A×V³0.59

where P is power, ρ is density, A is swept area, and V is velocity. The 0.59 constant is the Betz coefficient. The density of the air remains fairly constant at from about 1.0 to 1.2. The remaining two variables are both maximized in the system of the present invention.

Without wishing to be bound by theory, it is believed that the wind energy system of the present invention enhances the power output in two ways: (1) increasing the velocity of the wind stream using Bernoulli's principle to configure the tunnel; and, (2) by expanding the swept area with the enlarged inlet and wind gatherer.

The greatest enhancement of wind speed—about eighty percent (80%)—is achieved at ambient wind speeds of less than 6 m/s (meters per second) and when the tunnel 24 is aligned with the predominant wind vector (due center). Substantial increases of about sixty percent (60%) are achieved at ambient wind speeds of 2-6 m/s. To prevent damage to the system 10, the turbine assembly 12 can be rotated to a “furled” or nonfunctional position out of the wind when ambient wind speeds exceed a preselected maximum. Again, the preferred control system will include this protective feature.

Notably, these enhanced wind speeds are achieved even when the tunnel 24 is not perfectly aligned with the predominant wind vector; indeed, these levels of increased speed are achieved within twenty degrees to either side of the exact or “true center” of the wind tunnel 24, that is, the longitudinal axis “X” of the tunnel (FIG. 27). This factor should be considered when programming the control system; since significant enhancement of wind speed is achieved even when the inlet 30 is slightly off center (within twenty degrees either side) of the wind vector, the rotational movements of the system may be minimized. As used herein, “wind vector” refers to a line parallel to the predominant direction of wind.

As indicated, the preferred wind energy system 10 includes a control system for repetitively repositioning the turbine assembly in response to predicted wind change data. Wind change forecasts for the specific location of the wind energy system are received repeatedly from a third party transmitting the forecasts and are stored in a data storage device, such as a general purpose computer programmed to automatically receive, store and process the weather data. This wind change forecasting is done by a third party who bases the forecasts on data from mesonet stations and then predicts real-time changes in wind speed and direction for the targeted location. In the case of the wind energy system of the present invention, “targeted location” refers to the location of the wind energy system. One preferred weather service is Weather Decision Technologies, Inc., (“WDT”) headquartered in Norman, Okla. WDT offers a Wind Power Prediction System for wind power forecasting. See http://www.wdtinc.com.

The system and method of the present invention is based on positioning the turbine in advance of wind changes based on predictive data, such as the wind power forecasting data referred to above. To that end, the control system calculates the optimum turbine position, based on the predictive wind direction data, and then rotates the platform to that position prior to the predicted wind change event. This allows the energy captured to be maximized and minimizes the “windsock” effect of a noncontrolled system. “Wind data” as used herein means wind speed and/or wind direction. “Wind changes” refers to changes in the wind speed or direction or both.

Notable, the preferred system is constructed so that it is not responsive directly to wind changes that physically impact the system, as is the case with a ruddered system. Rather, in the preferred embodiment, the platform rotates only in response to the control system's commands based on predictive wind change data.

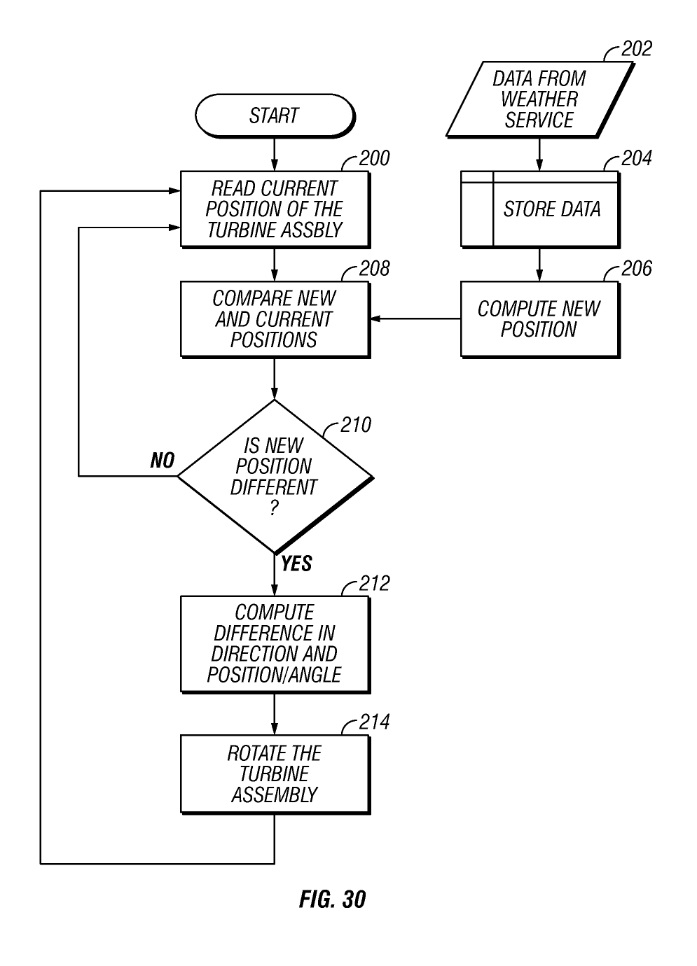

A basic algorithm for controlling the rotational position of the turbine assembly 12 is depicted in FIG. 30. In step 200, the control system reads the current position of the turbine assembly 12. For example, the longitudinal axis of the tunnel 26 may be aligned with 180 degrees on the possible 360 degree range of rotation. In step 202, the control system receives updated wind change data, and in step 204 this data is stored in the control system's memory.

The wind change forecasts may be updated regularly at selected intervals. As used herein, “continuously” when used to describe the frequency of updating the wind data or repositioning the turbine assembly or the turbine means at regular intervals. For example, the control system may be updated every 10 minutes, hourly, daily, or weekly. It should be noted that for ordinary weather conditions, the updates may be less frequent than in acute weather conditions, such as wind storms or tornadoes. This is because the data relating to normal prevailing winds may be provided from sites that are as much as 200 miles away, suggesting an update frequency of twenty (20) minutes. On the other hand, data relating to the path of a tornado or the likelihood of damaging winds in the target area may be as close as 20 miles away, suggesting that the data updates should be temporarily accelerated to every five (5) minutes, for example.

In step 206, the processor computes the correct rotational position of the turbine assembly 12 so that the tunnel 24 will be aligned with the next predicted wind vector. In step 208, the processor compares the calculated position for the new data with the current position of the turbine assembly 12. In step 210, the processor determines if the new position and the current position are different. If yes, then in step 212, the difference in the direction and angle of the turbine assembly 12 is determined. Next, in step 214, the communication interface sends a signal to the rotational motor to rotate the turbine assembly 12 to the new position. If no, then the process returns to and repeats step 200.

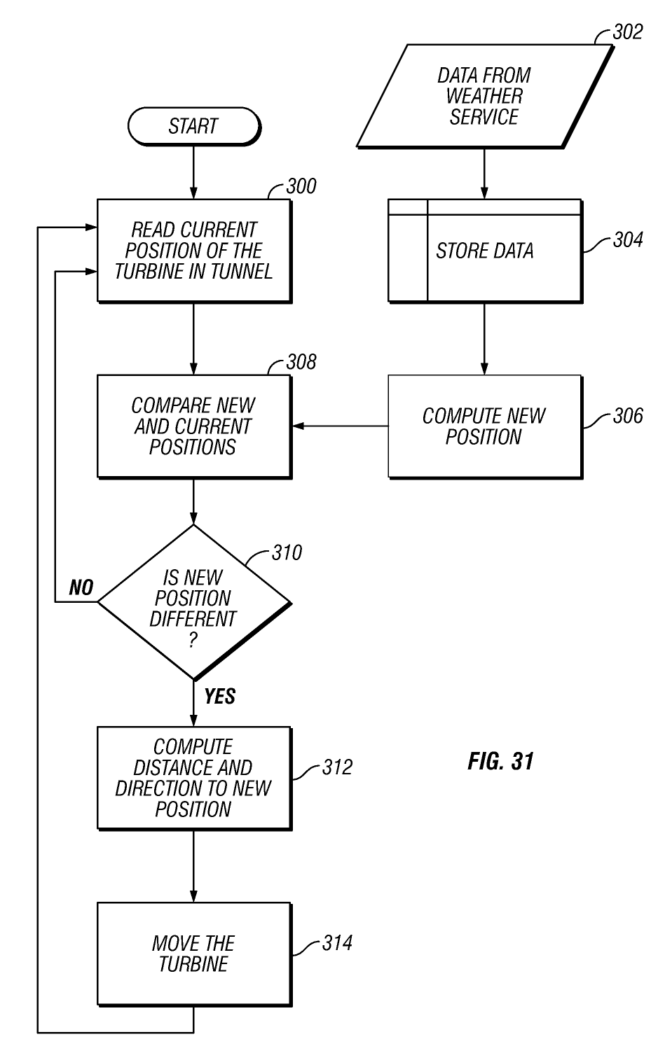

A basic algorithm for controlling the axial position of the turbine 26 is depicted in FIG. 31. In step 300, the control system reads the current position of the turbine 26. For example, the turbine 26 may be positioned at 12 inches behind the reference point, that is, the smallest diameter point in the throat.

In step 302, the control system receives updated wind change data, and specifically, the next predicted wind speed. In step 304 this data is stored in the control system's memory. The wind change forecasts may be updated at selected intervals. For example, the control system may be updated every 10 minutes, hourly, daily, or weekly

In step 306, the processor computes the correct axial position of the turbine 26 so that it will be in the sweet spot, the position in the tunnel where the maximum wind velocity will be generated. In step 308, the processor compares the calculated position for the new data with the current position of the turbine 26 in the tunnel 24. In step 310, the processor determines if the new position and the current position are different. If yes, then in step 312, the difference in the direction (fore or aft) and distance of the turbine 26 is determined. Next, in step 314, the communication interface sends a signal to the linear drive motor to move the turbine 26 fore or aft to the new position. If no, then the process returns to and repeats step 300.

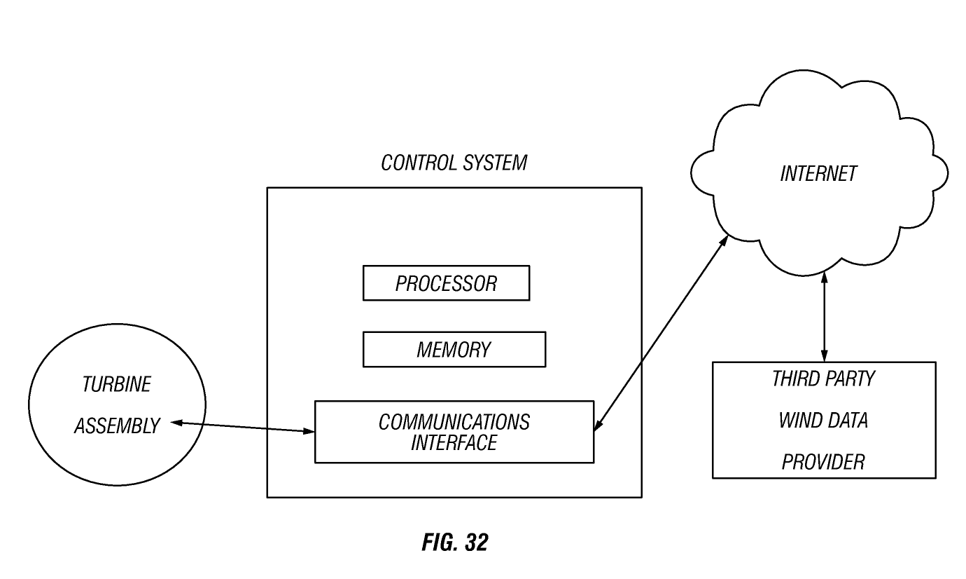

With reference now to FIG. 32, a preferred computer control system for executing the methods of FIGS. 30 and 31 will be described. The control system is designated generally herein at 400. The control system 400 comprises a processor 402, a memory 404, and a communication interface 406. The communications interface communicates via the Internet 408, preferably wirelessly, with the wind data supplier 410. The communications interface 406 also communicates control instructions to the turbine assembly 12, and more specifically, to the rotational and linear drive mechanisms. Still further, the communications interface 406 receives data reflecting conditions in the wind tunnel, such as wind speed, as generated by anemometers (not shown).

The processor 402 may comprise a universal purpose or application specific computing hardware, such as universal central processing units (CPUs) or application-specific integrated circuits (ASICs) which both may be combined with appropriate software to configure the functions of the method.

Now it will be appreciated that the wind energy system and method of the present invention provides a low-profile, minimal footprint installation that can be easily camouflaged to blend in with the surrounding environment. By way of comparison, a typical tower mounted wind turbine may be 165 feet high, while a ground-based wind energy system as taught herein may be only 50 feet high or less.

Because the turbine blades are contained inside the wind tunnel, the unpleasing “flicker” effect of blades passing across the sun is eliminated. Because the tunnel is at ground level and can be covered with a screen, injury to birds and other wildlife is minimized. Yet another benefit of having the turbine at ground level is the ease of repair and maintenance, which is both safer and less expensive. Because of the wind enhancement properties of the turbine assembly, sites not heretofore considered for wind energy devices can be exploited. This provides the opportunity for more turbines to be placed in lower wind class sites near the grid.

The embodiments shown and described above are exemplary. Many details are often found in the art and, therefore, many such details are neither shown nor described. It is not claimed that all of the details, parts, elements, or steps described and shown were invented herein. Even though numerous characteristics and advantages of the present inventions have been described in the drawings and accompanying text, the description is illustrative only. Changes may be made in the details, especially in matters of shape, size, and arrangement of the parts within the principles of the inventions to the full extent indicated by the broad meaning of the terms of the attached claims. The description and drawings of the specific embodiments herein do not point out what an infringement of this patent would be, but rather provide an example of how to use and make the invention. Likewise, the abstract is neither intended to define the invention, which is measured by the claims, nor is it intended to be limiting as to the scope of the invention in any way. Rather, the limits of the invention and the bounds of the patent protection are measured by and defined in the following claims.

What is claimed is:

1. A wind energy system comprising:
a wind turbine mounted for rotation;
a control system adapted to receive regularly updated real-time wind direction forecasts and in response to each such updated forecast automatically to align the wind turbine with the next predicted wind vector in advance of the predicted change.

2. A wind energy system comprising:
a wind tunnel defining an inlet, an outlet, and a narrowed throat area therebetween configured to increase the speed of ambient winds entering the inlet; and
a wind turbine positioned downwind of the throat area of the tunnel and movable axially relative to the throat area in response to predicted changes in ambient wind speed.

3. A method for generating energy from wind comprising:
regularly repositioning a wind turbine in response to regularly updated real-time wind direction forecasts by rotating the turbine into alignment with the next predicted wind vector.

4. A method for generating energy from wind comprising:
regularly repositioning a wind turbine axially relative to a wind tunnel with a narrowed throat, the repositioning being in response to regularly updated real-time wind speed forecasts by moving the turbine axially to the point of maximum wind speed in the tunnel based on the next predicted wind speed and in advance of the predicted change in wind speed.
